(19) United States
(12) Patent Application Publication
(10) Pub. No.: US 2022/0026837 A1
(43) Pub. Date: Jan. 27, 2022

(54) HEATING DEVICE, LIQUID APPLYING APPARATUS, IMAGE FORMING APPARATUS, POST-PROCESSING APPARATUS, AND CONVEYING DEVICE

(71) Applicant: RICOH COMPANY, LTD., Tokyo (JP)

(72) Inventors: Takamasa HASE, Kanagawa (JP); Takashi SETO, Kanagawa (JP)

(73) Assignee: RICOH COMPANY, LTD., Tokyo (JP)

(21) Appl. No.: 17/371,947

(22) Filed: Jul. 9, 2021

(30) Foreign Application Priority Data
Jul. 27, 2020 (JP) 2020-126478

(51) Int. Cl. G03G 15/20

(52) U.S. Cl. CPC G03G 15/2064; G03G 2215/2035; G03G 15/2053

(57) ABSTRACT

A heating device includes a pair of rotary bodies and a heat source. The pair of rotary bodies includes a first rotary body and a second rotary body in contact with each other to form a nip region. The pair of rotary bodies is configured to convey a sheet on which liquid is applied while nipping the sheet. The pressed amount of the second rotary body by the first rotary body increases from an upstream end of the nip region toward a downstream end of the nip region in a sheet conveyance direction. The heat source is configured to heat at least one of the first rotary body and the second rotary body.

### CROSS-REFERENCE TO RELATED APPLICATION

This patent application is based on and claims priority pursuant to 35 U.S.C. § 119(a) to Japanese Patent Application No. 2020-126478, filed on Jul. 27, 2020, in the Japan Patent Office, the entire disclosure of which is incorporated by reference herein.

### BACKGROUND

### Technical Field

Embodiments of the present disclosure relate to a heating device, a liquid applying apparatus, an image forming apparatus, a post-processing apparatus, and a conveying device.

### Related Art

Various types of heating devices are provided in image forming apparatuses such as copiers and printers. As one type of heating device, a drying device is known to heat a sheet to dry liquid on the sheet.

For example, a known drying device conveys a sheet while stretching the sheet by a plurality of rollers, so as to heat the sheet while eliminating the cockling (waving) of the sheet to dry ink on the sheet.

### SUMMARY

Embodiments of the present disclosure described herein provide a novel heating device including a pair of rotary bodies and a heat source. The pair of rotary bodies includes a first rotary body and a second rotary body in contact with each other to form a nip region. The pair of rotary bodies is configured to convey a sheet on which liquid is applied while nipping the sheet. The pressed amount of the second rotary body by the first rotary body increases from an upstream end of the nip region toward a downstream end of the nip region in a sheet conveyance direction. The heat source is configured to heat at least one of the first rotary body and the second rotary body.

Further, embodiments of the present disclosure described herein provide a liquid applying apparatus including a liquid applier configured to apply liquid to a sheet, and the above-described heating device.

Further, embodiments of the present disclosure described herein provide an image forming apparatus including an image forming device configured to apply liquid to a sheet to form an image, and the above-described heating device.

Further, embodiments of the present disclosure described herein provide a post-processing apparatus including the above-described heating device, and a post-processing device configured to process the sheet conveyed from the heating device.

Further, embodiments of the present disclosure described herein provide a conveying device including the above-described heating device, and a sheet conveyance passage configured to convey the sheet to a post-processing device configured to process the sheet conveyed from the heating device.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram illustrating a schematic configuration of an image forming apparatus according to an embodiment of the present disclosure;

FIG. 2 is a diagram illustrating a schematic configuration of a drying device provided in the image forming apparatus of FIG. 1, according to an embodiment of the present disclosure;

FIG. 3 is a diagram illustrating a sheet in the drying device of FIG. 2, in which cockling occurs on a sheet in a sheet conveyance direction;

FIG. 4 is a diagram illustrating a sheet in the drying device of FIG. 2, in which cockling occurs on the sheet in a direction that intersects the sheet conveyance direction;

FIG. 5 is an enlarged view of a part around a nip region of the drying device of FIG. 2;

FIG. 6 is a diagram illustrating a surface travel distance per unit time when a pressure roller rotates;

FIG. 7 is a diagram illustrating how a sheet enters the drying device of FIG. 2 and cockling is reduced;

FIG. 8A is a diagram illustrating a configuration of the drying device according to Example 1 of the present disclosure;

FIGS. 8B-A to 8B-E are graphs related to the configuration of the drying device of FIG. 8A;

FIG. 9A is a diagram illustrating a configuration of the drying device according to Example 2 of the present disclosure;

FIGS. 9B-A to 9B-E are graphs related to the configuration of the drying device of FIG. 9A;

FIG. 10A is a diagram illustrating a configuration of a comparative drying device according to Comparative Example 1;

FIGS. 10B-A to 10B-E are graphs related to the configuration of the comparative drying device of FIG. 10A;

FIG. 11A is a diagram illustrating a configuration of the comparative drying device according to Comparative Example 2;

FIGS. 11B-A to 11B-E are graphs related to the configuration of the comparative drying device of FIG. 11A;

FIG. 12 is a diagram for explaining the average of press amount for each of the first half and the second half of the nip region;

FIG. 13 is a diagram for explaining the preferred thickness of the elastic layer of the pressure roller;

FIG. 14 is a diagram illustrating a configuration of a downstream roller pair and the drying device of FIG. 2, in which the sheet conveyance speed of a downstream roller pair and the sheet conveyance speed of the drying device are different from each other;

FIG. 15 is a diagram illustrating a configuration of a drying device according to another embodiment of the present disclosure;

FIG. 16 is a diagram illustrating a configuration of the drying device of FIG. 15, in which a sheet enters the drying device so that the cockling on the sheet is reduced;

FIG. 17 is a diagram illustrating a configuration of a drying device according to yet another embodiment of the present disclosure;

FIG. 18 is a diagram illustrating a configuration of the drying device of FIG. 17, in which a sheet enters the drying device so that the back curl on the sheet is reduced;

FIG. 19 is a diagram illustrating another configuration of the drying device illustrated in FIG. 17;

FIG. 20 is a diagram illustrating yet another configuration of the drying device illustrated in FIG. 17;

FIG. 21 is a diagram illustrating yet another configuration of the drying device illustrated in FIG. 17;

FIG. 22 is a diagram illustrating a belt with a convexo-concave outer surface;

FIG. 23 is a diagram illustrating a roller with a convexo-concave outer surface;

FIG. 24 is a diagram illustrating a belt with a plurality of abrasive grains bonded to the outer surface;

FIG. 25 is a diagram illustrating a roller with a plurality of abrasive grains bonded to the outer surface;

FIG. 26 is a diagram illustrating a drying device according to an embodiment of the present disclosure, in which a sheet is conveyed with the liquid-applied surface facing the pressure roller side;

FIG. 27 is a diagram illustrating a configuration of an image forming apparatus according to another embodiment of the present disclosure;

FIG. 28 is a diagram illustrating a configuration of an image forming apparatus according to yet another embodiment of the present disclosure;

FIG. 29 is a diagram illustrating a drying device according to the present disclosure, provided in a conveying device;

FIG. 30 is a diagram illustrating a drying device according to the present disclosure, provided in a post-processing apparatus; and

FIG. 31 is a diagram illustrating a liquid-applying method.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below. As used herein, the singular forms “a,” “an,” and “the” are intended to include the plural forms as well, unless the context clearly indicates otherwise.

Descriptions are given of an example applicable to a heating device, a liquid applying apparatus, an image forming apparatus, a post-processing apparatus, and a conveying device. In the drawings for explaining the embodiments of the present disclosure, identical reference numerals are assigned to elements such as members and parts that have an identical function or an identical shape as long as differentiation is possible and a description of those elements is omitted once the description is provided.

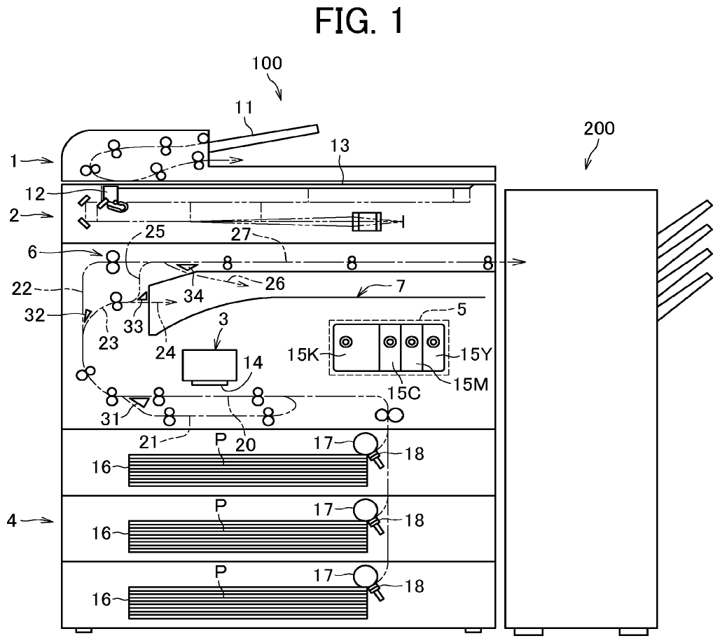

FIG. 1 is a diagram illustrating a schematic configuration of an image forming apparatus according to an embodiment of the present disclosure.

As illustrated in FIG. 1, an image forming apparatus 100 according to the present embodiment includes an original document conveying device 1, an image reading device 2, an image forming device 3, a sheet feeding device 4, a cartridge container 5, a drying device 6, and a sheet ejection portion 7. Further, a post-processing apparatus 200 is disposed adjacent to the image forming apparatus 100.

The original document conveying device 1 separates an original document from the other original documents one by one from a set of original documents on an original document tray 11 and conveys the separated original document toward an exposure glass 13 of the image reading device 2. The original document conveying device 1 includes a plurality of conveyance rollers each functioning as an original document conveyor to convey the original document.

The image reading device 2 is an image scanner, that is, a device to scan the image on an original document placed on the exposure glass 13 or the image on an original document as the original document passes over the exposure glass 13. The image reading device 2 includes an optical scanning unit 12 as an image reading unit. The optical scanning unit 12 includes a light source that irradiates an original document placed on the exposure glass 13 with light, and a charge-coupled device (CCD) as an image reader that reads an image from the reflected light of the original document. Further, a close contact-type image sensor (CIS) may be employed as an image reader.

The image forming device 3 includes a liquid discharge head 14 that functions as a liquid applier to apply liquid to a sheet. The liquid discharge head 14 discharges ink to apply the ink to the sheet. The ink is liquid used for image formation. The liquid discharge head 14 may be a serial-type liquid discharge head that discharges ink while moving in the main scanning direction of a sheet (i.e., the sheet width direction) or a line-type liquid discharge head that discharges ink without moving a plurality of liquid discharge heads aligned in the main scanning direction.

Ink cartridges 15Y, 15M, 15C, and 15K are detachably attached to the cartridge container 5. The ink cartridges 15Y, 15M, 15C, and 15K are filled with inks of different colors such as yellow, magenta, cyan, and black, respectively. The ink in each ink cartridge (i.e., the ink cartridges 15Y, 15M, 15C, 15K) is supplied to the liquid discharge head 14 by an ink supply pump.

The drying device 6 is a heating device that heats the sheet while nipping the sheet between a pair of rotary bodies in order to dry ink on the sheet. The pair of rotary bodies includes, for example, a heat belt 40 and a pressure roller 41, described below. The detailed description of the configuration of the drying device 6 is deferred.

The sheet feeding device 4 includes a plurality of sheet feed trays 16 each functioning as a sheet container. Each sheet feed tray 16 loads a bundle of sheets including a sheet P. Each sheet P on which an image is formed is a cut sheet cut in a predetermined size, e.g., A4 size and B4 size, and is previously contained in the sheet feed tray 16 in a corresponding sheet conveyance direction. Further, each sheet feed tray 16 includes a sheet feed roller 17 that functions as a sheet feeder and a sheet separation pad 18 that functions as a sheet separator.

The post-processing apparatus 200 is a device that performs post-processing, such as aligning, on sheets conveyed from the image forming apparatus 100. The post-processing apparatus 200 may include a post-processing device such as a sheet aligner that aligns a plurality of sheets and ejects the plurality of sheets to a tray. The post-processing device of the post-processing apparatus 200 may further include a hole puncher that punches the sheet to make a hole or holes in the sheet, a sheet binder that binds the plurality of sheets, or a folder that folds sheets in two or three.

To provide a fuller understanding of the embodiments of the present disclosure, a description is now given of the image forming operation of the image forming apparatus 100 according to the present embodiment of this disclosure, with continued reference to FIG. 1.

As an instruction is given to start the printing operation, the sheet P is fed from one sheet feed tray 16 of the plurality of sheet feed trays 16. To be more specific, as the sheet feed roller 17 rotates, the uppermost sheet P placed on top of the bundle of sheets P contained in the sheet feed tray 16 is fed by the sheet feed roller 17 and the sheet separation pad 18 while the uppermost sheet P is separated from the other sheets of the bundle of sheets.

When the sheet P is conveyed to a sheet conveyance passage 20 that extends in the horizontal direction and faces the image forming device 3, the image forming device 3 forms an image on the sheet P. To be more specific, the liquid discharge head 14 is controlled to discharge liquid (ink) according to image data of the original document read by the image reading device 2 or print data instructed to print by an external device, so that ink is discharged on the image forming surface (upper face) of the sheet P to form an image. Note that the image to be formed on the sheet P may be a meaningful image such as text or a figure, or a pattern having no meaning per se.

When a duplex printing is performed, the sheet P is conveyed in the opposite direction opposite the sheet conveyance direction at a position downstream from the image forming device 3 in the sheet conveyance direction, so that the sheet P is guided to a sheet reverse passage 21. To be more specific, after the trailing end of the sheet P has passed a first passage changer 31 that is disposed downstream from the image forming device 3 in the sheet conveyance direction, the first passage changer 31 changes the sheet conveyance passage of the sheet P to the sheet reverse passage 21, so that the sheet P is conveyed in the opposite direction. Accordingly, the sheet P is guided to the sheet reverse passage 21. Then, as the sheet P passes through the sheet reverse passage 21, the sheet P is reversed upside down and conveyed to the image forming device 3 again. Then, the image forming device 3 repeats the same operation performed on the front face of the sheet P, so as to form an image on the back face of the sheet P.

A second passage changer 32 is disposed downstream from the first passage changer 31 in the sheet conveyance direction. The second passage changer 32 guides the sheet P with the image selectively to a sheet conveyance passage 22 that runs through the drying device 6 or to a sheet conveyance passage 23 that does not run through the drying device 6. When the sheet P is guided to the sheet conveyance passage 22 through which the sheet P passes the drying device 6, the drying device 6 dries the ink on the sheet P. On the other hand, when the sheet P is guided to the sheet conveyance passage 23 through which the sheet P does not pass the drying device 6, a third passage changer 33 guides the sheet P selectively to a sheet conveyance passage 24 toward the sheet ejection portion 7 or to a sheet conveyance passage 25 toward the post-processing apparatus 200. Further, after the sheet P has passed the drying device 6, a fourth passage changer 34 guides the sheet P selectively to a sheet conveyance passage 26 toward the sheet ejection portion 7 or to a sheet conveyance passage 27 toward the post-processing apparatus 200.

In a case in which the sheet P is guided to the sheet conveyance passage 24 or the sheet conveyance passage 26 toward the sheet ejection portion 7, the sheet P is ejected to the sheet ejection portion 7. On the other hand, in a case in which the sheet P is guided to the sheet conveyance passage 25 or the sheet conveyance passage 27 toward the post-processing apparatus 200, the sheet P is conveyed to the post-processing apparatus 200, so that the sheet P is ejected after the post-processing operation is performed on the sheet P. In the present embodiment, the sheet P is sent to the sheet ejection portion 7 or the post-processing apparatus 200 with the image forming surface (the surface to which ink is applied in the case of single-sided printing) facing down, that is generally referred to as a face-down ejection. Although the face-down sheet ejection method is employed in the present embodiment, the method is not limited to this method. For example, the present disclosure may use a face-up sheet ejection method in which the sheet P is fed with the image forming surface facing up.

As described above, a series of printing operations is completed.

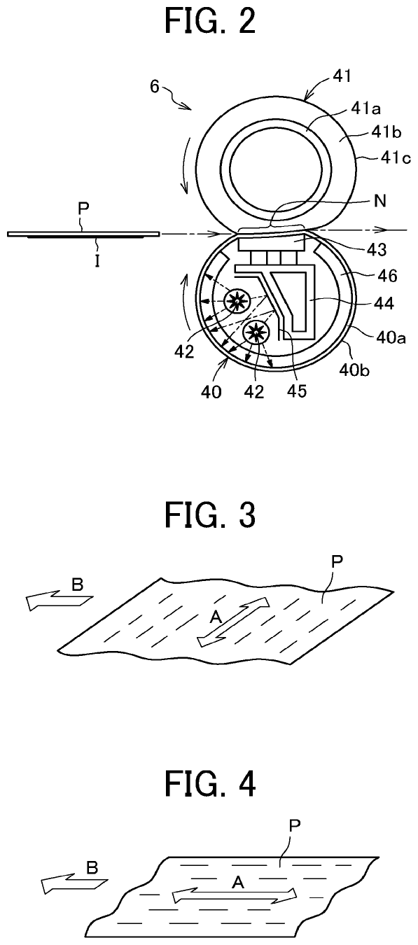

Now, a description is given of a configuration of the drying device according to the present embodiment, with reference to FIG. 2.

As illustrated in FIG. 2, the drying device 6 according to the present embodiment includes a heat belt 40, a pressure roller 41, a heater 42, a nip formation pad 43, a stay 44, a reflector 45, and belt holding members 46.

The heat belt 40 is an endless belt (including a film) as a rotary body to be heated by the heater 42. Specifically, the heat belt 40 includes a base 40a having a flexible endless loop and a release layer 40b provided on the outer peripheral surface of the base 40a. The base 40a is made of metal, such as nickel or SUS, or resin such as polyimide. Further, the release layer 40b is made of tetrafluoroethylene-perfluoroalkyl vinyl ether copolymer (PFA) or polytetrafluoroethylene (PTFE).

The pressure roller 41 is an elastic roller as a rotary body that is pressed against the heat belt 40. Specifically, the pressure roller 41 is provided on a base (core metal) 41a having a cylindrical or columnar shape, an elastic layer 41b provided on the outer peripheral surface of the base 41a, and a release layer 41c provided on the outer peripheral surface of the elastic layer 41b. The base 41a is made of metal such as an iron-based alloy. Further, the elastic layer 41b is made of an elastic material such as silicone rubber, sponge rubber, or solid rubber. Similar to the heat belt 40, the release layer 41c is made of a fluororesin such as PFA or PTFE.

Each heater 42 is a halogen heater as a heat source to heat the heat belt 40. The heat source may be one of various types of heat sources, for example, a halogen heater, a radiant heater such as a carbon heaters or a ceramic heater, and an electromagnetic induction heating system. The heat source is not limited to a device placed inside the heat belt 40 but may be placed outside the heat belt 40. Further, the number of heat sources may be two or more (two in the example illustrated in FIG. 2) or one. Further, another heater as a heat source may be separately placed inside the pressure roller 41.

The nip formation pad 43 is a member arranged inside the heat belt 40 and nipping the heat belt 40 with the pressure roller 41 to form the nip region N. The nip formation pad 43 and the pressure roller 41 are biased so as to be relatively close to each other, so that the nip formation pad 43 and the pressure roller 41 are in press contact with each other via the heat belt 40 to form the nip region N. Further, the nip formation pad 43 and the pressure roller 41 may be biased so that one of the nip formation pad 43 and the pressure roller 41 approaches the other, or both may be biased so as to approach each other. The nip formation pad 43 preferably uses a heat-resistant material with a heat resistance temperature of 200 degrees Centigrade (° C.) or higher. Specifically, the nip formation pad 43 is made of a general heat-resistant resin such as polyether sulphon (PES), polyphenylene sulfide (PPS), liquid crystal polymer (LCP), polyether nitrile (PEN), polyamide imide (PAI), or PEEK (polyether ether ketone (PEEK). Since the nip formation pad 43 is made of such a heat-resistant material, deformation of the nip formation pad 43 due to heat is prevented, thus achieving a stable nip region N and stabilizing the output image quality.

The stay 44 is a support member that supports the nip formation pad 43 so that the nip formation pad 43 does not bend due to the pressure of the pressure roller 41. The stay 44 contacts the surface of the nip formation pad 43 that is the opposite surface facing the pressure roller 41 to support the nip formation pad 43. By supporting the nip formation pad 43 by the stay 44, the bending of the nip formation pad 43 (deflection in the pressing direction) due to the pressure of the pressure roller 41 is restrained over the longitudinal direction of the heat belt 40, and a nip region N is formed having a uniform width. The stay 44 is preferably made of an iron-based metal such as stainless steel (SUS) or steel electrolytic steel (SECC) to provide good rigidity.

The reflector 45 is a member that reflects the light (for example, infrared light) radiated from the heater 42 or the radiated heat toward the heat belt 40. Since the reflector 45 is provided inside the heat belt 40, the light emitted from the heater 42 is reflected by the reflector 45 onto the inner surface of the heat belt 40. By reflecting the light from the heater 42 by the reflector 45 in this way, the heat belt 40 is efficiently heated by the reflected light in addition to the light directly irradiated from the heater. Further, since the reflector 45 is interposed between the stay 44 and the heater 42, the light or heat emitted from the heater 42 toward the stay 44 is also reflected. Due to such a configuration, wasteful consumption of heat energy is reduced, and energy saving is achieved.

Alternatively, the stay 44 may have the function of the reflector 45. For example, by applying a mirror treatment to the surface of the stay 44 facing the heaters 42, the stay 44 may be configured to also function as the reflector 45. In this case, since the reflector 45 may not be provided separately, this configuration achieves downsizing and cost reduction.

The belt holding members 46 are a pair of holding members that holds the heat belt 40 at both ends in the longitudinal direction of the heat belt 40. Each belt holding member 46 has a C shape or a cylindrical shape and is inserted inward from both ends in the longitudinal direction of the heat belt 40. As a result, the heat belt 40 is held rotatably. Further, in the stationary state in which the heat belt 40 is not rotating, the heat belt 40 is basically held in a state in which the tension is not generated in the circumferential direction of the heat belt 40.

Next, a description is given of basic operations and effects of the drying device 6 according to the present embodiment, with reference to FIG. 2.

As illustrated in FIG. 2, when the pressure roller 41 is rotated by a drive source provided in the housing of the image forming apparatus 100, the driving force of the pressure roller 41 is transmitted to the heat belt 40 via the nip region N. As a result, the heat belt 40 is rotated. Further, each heater 42 generates heat, so that the heat belt 40 is heated from the inside. When the temperature of the heat belt 40 reaches a predetermined temperature (drying temperature) and the sheet P with the image enters between the heat belt 40 and the pressure roller 41 (nip region N), the surface of the sheet P on which the image is formed (the surface to which the ink is applied) contacts the heat belt 40 to be heated by the heat belt 40. This configuration accelerates the drying of the ink I on the sheet P. After the ink I on the sheet P is dried, the sheet P is ejected from the drying device 6 and conveyed to the sheet ejection portion 7 or the post-processing apparatus 200 selectively, as described above.

When a duplex printing is performed, after respective images are formed on both sides of the sheet, the sheet may be conveyed to the drying device 6 to dry both sides of the sheet at the same time. Alternatively, an image may be formed on the front surface of the sheet and dried, and another image may be formed on the back surface of the sheet and dried. However, when an image is formed on the back surface of the sheet after the front surface of the sheet is dried, it is desirable to convey the sheet to the image forming device 3 without passing through the drying device 6. Specifically, in the case of the configuration illustrated in FIG. 1, after the sheet is conveyed to the drying device 6, the sheet is switched back, guided to the sheet reverse passage 21 via the sheet conveyance passage 25 and the sheet conveyance passage 23, and conveyed to the image forming device 3. Alternatively, the sheet may be conveyed to the upstream side of the sheet conveyance passage 22 (upstream from the drying device 6) in the sheet conveyance direction via another sheet conveyance passage that bypasses the drying device 6, without passing through the sheet conveyance passage 25 or the sheet conveyance passage 23, so that the sheet is guided to the sheet reverse passage 21.

Now, a description is given of cockling (waving) that occurs on the sheet.

In a known inkjet image forming apparatus, when ink is applied to a sheet, the solvent in the ink penetrates the fibers of the sheet, causing the fibers to stretch unevenly and the degree of stretching to differ between the area in which the ink is applied and the area in which the ink is not applied. This inconvenience is likely to cause the sheet to wave, which is referred to as cockling. Generally, cockling occurs over the direction that intersects the fiber direction of the sheet. That is, as illustrated in FIG. 3, when the fiber direction A of the sheet P intersects with the sheet conveyance direction B (sheet conveyance direction), cockling occurs over the sheet conveyance direction B. As illustrated in FIG. 4, when the fiber direction A of the sheet P is the same direction as the sheet conveyance direction B, cockling occurs over the direction that intersects with the sheet conveyance direction B (hereafter referred to as the “sheet width direction”).

Generation of such a cockling on the sheet may cause inconveniences such as a conveyance failure by the sheet being caught in the middle of conveyance and an inconvenience to decrease the number of sheets stackable in the sheet ejection portion 7. Due to such a configuration, the image forming apparatus 100 according to the present embodiment provides countermeasures to effectively restrain deformation of a sheet such as cockling.

Hereinafter, a detailed description is given of the configuration of the image forming apparatus 100 according to the present embodiment to effectively restrain deformation of a sheet.

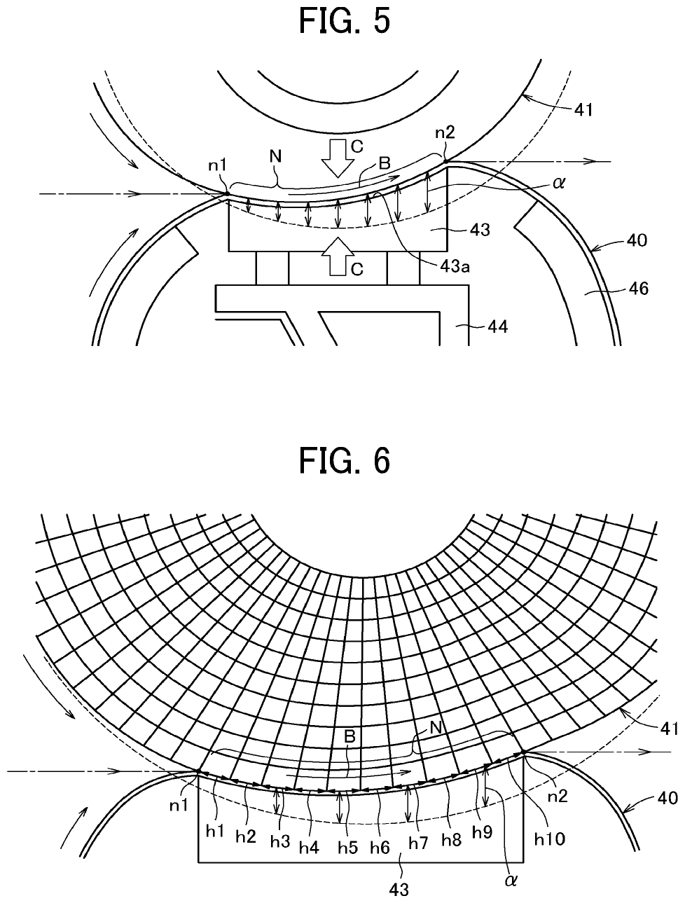

FIG. 5 is an enlarged view illustrating a part around the nip region of the drying device according to the present embodiment.

As illustrated in FIG. 5, in the present embodiment, the nip formation pad 43 includes the nip forming surface 43a (the surface in contact with the inner peripheral surface of the heat belt 40). The nip forming surface 43a is formed in a concave curved shape to increase the height to the pressure roller 41 (upper side in FIG. 5) toward the downstream side of the sheet conveyance direction B.

Thus, in the present embodiment, since the nip forming surface 43a is formed in the concave curve shape to increase the height to the pressure roller 41 toward the downstream side of the sheet conveyance direction B, when the pressure roller 41 is pressed toward the nip formation pad 43, the nip region N is formed in the concave curved shape that is concave toward the heat belt 40 from the upstream end n1 to the downstream end n2 in the sheet conveyance direction B, following the shape of the nip forming surface 43a. At the same time, the nip region N is formed so that the downstream end n2 of the nip region N in the sheet conveyance direction B is located closer to the axial center of the pressure roller 41 than the upstream end n1 is.

The pressed amount α is defined as the amount of deformation of the pressure roller 41 in the pressing direction C from the non-pressed state in which the pressure roller 41 is not pressed at all (the state illustrated by the dotted line in FIG. 5) to the pressed state in which the pressure roller 41 is pressed against the heat belt 40 and the nip region N is formed. In the present embodiment, the pressed amount a of the pressure roller 41 increases continuously from the upstream end n1 to the downstream end n2 in the sheet conveyance direction B of the nip region N. In other words, the pressed amount α does not temporarily decrease or remain constant through the nip region N, but constantly increases over the entire area from the upstream end n1 to the downstream end n2 in the sheet conveyance direction B of the nip region N. Note that, as long as the pressed amount a increases toward the downstream side in the sheet conveyance direction B of the nip region N, the nip forming surface 43a and the nip region N are not limited to the case in which the entire surface is formed in the concave curved shape, but may also have flat areas in some parts. The pressure roller 41 is usually pressed in a direction perpendicular to the surface on which the nip formation pad 43 and the stay 44 contact. In that case, the direction perpendicular to the surface on which the nip formation pad 43 and the stay 44 contact may be used as the above-described pressure direction C.

As described above, in the present embodiment, the pressed amount α of the pressure roller 41 increases from the upstream end n1 to the downstream end n2 of the nip region N, so that the following effects may be produced on the sheet entering the nip region N.

FIG. 6 is a diagram illustrating the surface movement distances h1 to h10 per unit time when the pressure roller 41 rotates in the present embodiment.

Generally, as the pressed amount a of the pressure roller 41 increases, the elastic layer is more compressed, and the surface (outer peripheral surface) of the pressure roller 41 expands greatly in the rotation direction (circumferential direction) of the pressure roller 41. In the present embodiment, the pressed amount α increases toward the downstream side of the sheet conveyance direction B, so that the surface movement distances h1 to h10 of the pressure roller 41 per unit time illustrated in FIG. 6 are on the downstream side of the sheet conveyance direction B. The relation of the surface movement distances H1 to h10 of the pressure roller 41 per unit time is expressed as h1<h2<h3<h4<h5<h6<h7<h8<h9<h10. Further, since the surface movement distances h1 to h10 per unit time may be rephrased as the surface moving speed, in the present embodiment, the surface moving speed of the pressure roller 41 is faster on the downstream side of the sheet conveyance direction B of the nip region N.

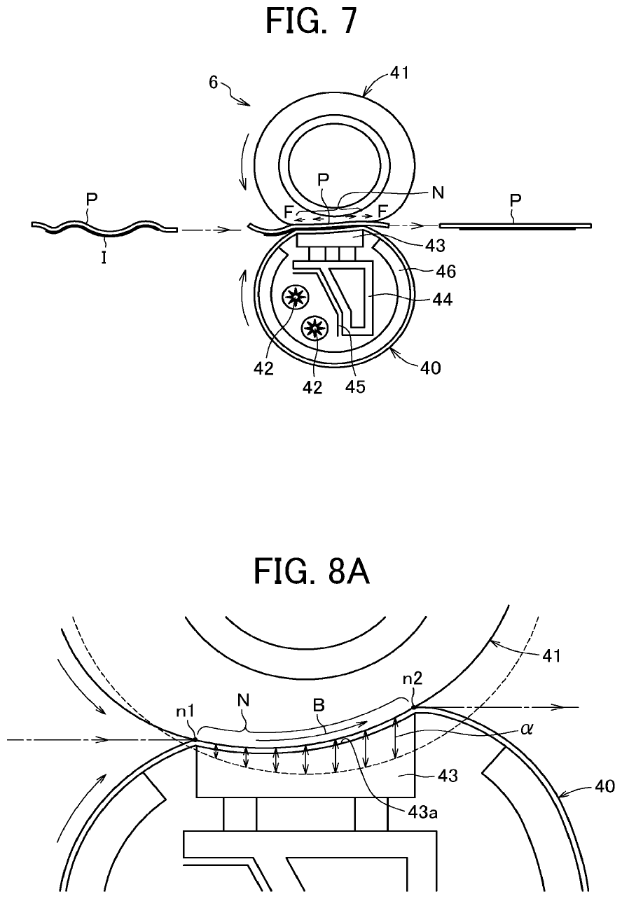

Thus, in the present embodiment, since the surface moving speed of the pressure roller 41 is faster on the downstream side of the sheet conveyance direction B of the nip region N, as illustrated in FIG. 7. Due to such a configuration, when the sheet P enters the nip region N, the tension F (shearing force) acts on the sheet P in the sheet conveyance direction B and the opposite direction to the sheet conveyance direction B due to the difference in the surface moving speed between the upstream side and the downstream side of the nip region N. Moreover, since the surface moving speed increases from the upstream end n1 to the downstream end n2 of the nip region N, the tension F constantly acts on the sheet P at any position of the nip region N while the sheet P is passing through the nip region N.

As illustrated in FIG. 7, even if the sheet P enters the nip region N with cockling in the sheet conveyance direction B, the sheet P is stretched by the tension F acting on the sheet P in the sheet conveyance direction B and in the opposite direction, thereby reducing or eliminating the cockling. That is, when the sheet P enters the nip region N, the pressure in the nip region N temporarily reduces the cockling of the sheet P, and the tension F acting on the sheet P stretches the fibers of the sheet P uniformly in the sheet conveyance direction B and in the opposite direction. Then, as the sheet P is heated while the sheet P is stretched, the solvent that permeates the sheet P volatilizes, and the sheet P dries with the fibers being stretched uniformly. As a result, the cockling of the sheet P is reduced, and the sheet P is ejected from the nip region N in a state where the cockling is continuously reduced.

As described above, the drying device 6 according to the present embodiment generates tension F against the sheet P in the nip region N, thus effectively reducing the cockling of the sheet P. This configuration eliminates problems, for example, sheet conveyance failure and a decrease in the number of sheets stackable in a sheet ejection tray, due to cockling. Further, the drying device 6 according to the present embodiment applies tension F to the sheet P simply by causing the sheet P to pass through the nip region N, even if the drying device 6 does not have a configuration in which the sheet P is stretched over a plurality of rollers. Due to such a configuration, cockling is effectively reduced even in an image forming apparatus that uses cut sheets or other sheets cut to a predetermined size in the sheet conveyance direction.

Next, a description is given of the effectiveness confirmation test of the present disclosure.

Effectiveness Confirmation Test

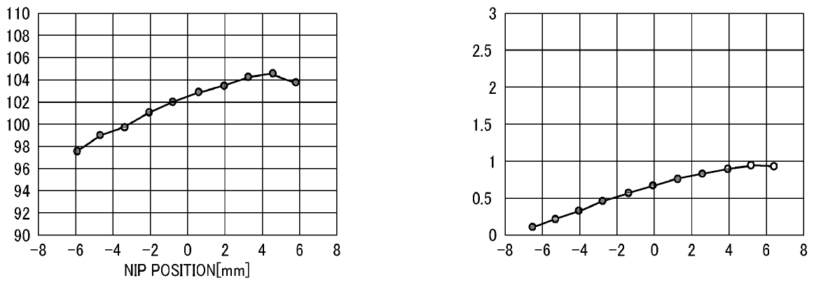

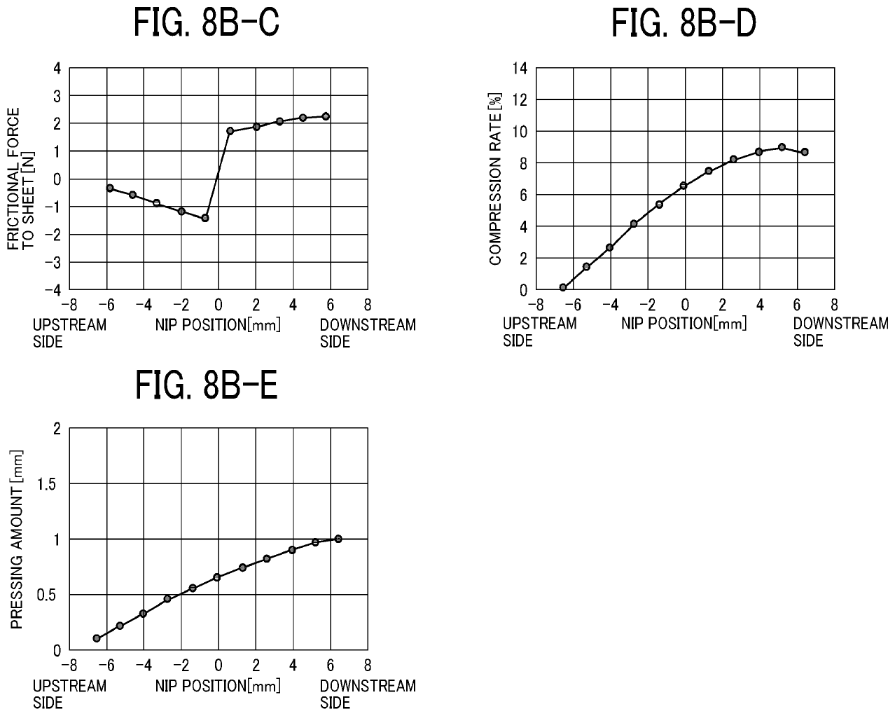

In this test, a drying device according to an embodiment of the present disclosure and a comparative drying device that is different from an embodiment of the present disclosure were prepared, and each drying device was provided in the same type of inkjet imaging forming apparatus to evaluate the cockling reduction effect. The sheets of paper used in this test were “My Paper” manufactured by Ricoh Company, Ltd, and water-based ink was applied to the sheet at a volume of 4.0 μl/inch² (solid coating), and the sheet was conveyed at a speed of 200 mm/s through each drying device. The temperature of the heating belt in each drying device was set to 120 degrees Centigrade (° C.). FIGS. 8A to 11B-E illustrate detailed configurations of examples of the drying device according to the present disclosure and comparative examples of the comparative drying device.

Each of FIGS. 8B-A, 9B-A, 10B-A, and 11B-A illustrates the surface moving speed ratio (linear velocity ratio) of the pressure roller, each of FIGS. 8B-B, 9B-B, 10B-B, and 11B-B illustrates the surface pressure of the pressure roller, each of FIGS. 8B-C, 9B-C, 10B-C, and 11B-C illustrates the frictional force generated against the paper, each of FIGS. 8B-D, 9B-D, 10B-D, and 11B-D illustrates the compression ratio of the pressure roller in the pressure direction, and each of FIGS. 8B-E, 9B-E, 10B-E, and 11B-E illustrates the pressed amount of the pressure roller in the pressing direction. Regarding the frictional force illustrated in FIGS. 8B-C, 9B-C, 10B-C, and 11B-C, the positive direction of the vertical axis indicates the frictional force generated in the sheet conveyance direction B, and the negative direction of the vertical axis indicates the frictional force generated in the direction opposite to the sheet conveyance direction B.

FIG. 8A is a diagram illustrating a configuration of the drying device according to Example 1 of the present disclosure. In Example 1, as in the embodiment described above, the nip forming surface 43a of the nip formation pad 43 has a concave curved shape to increase the height to the pressure roller 41 at the downstream side of the sheet conveyance direction B. Due to such a configuration, the pressed amount a of the pressure roller 41 increases over the entire area from the upstream end n1 to the downstream end n2 of the nip region N (see FIG. 8B-E).

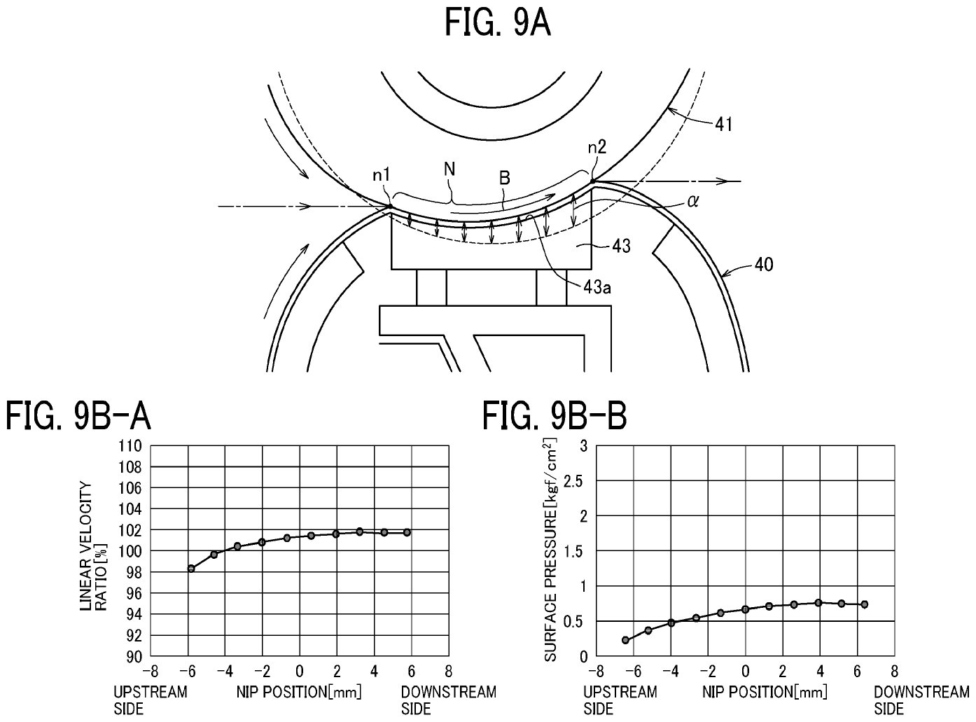

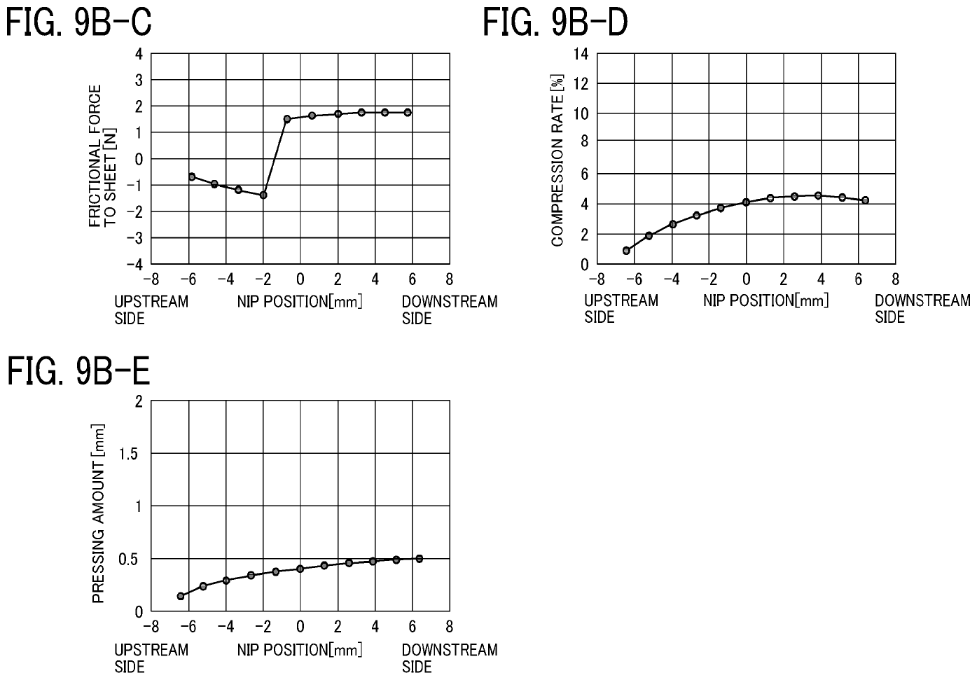

FIG. 9A is a diagram illustrating a configuration of the drying device according to Example 2 of the present disclosure. In Example 2, as in Example 1, the pressed amount α of the pressure roller 41 increases from the upstream end n1 of the nip region N toward the downstream end n2 (see FIG. 9B-E). However, the rate of increase in the pressed amount a in Example 2 is smaller than the rate of increase in the pressed amount α in Example 1.

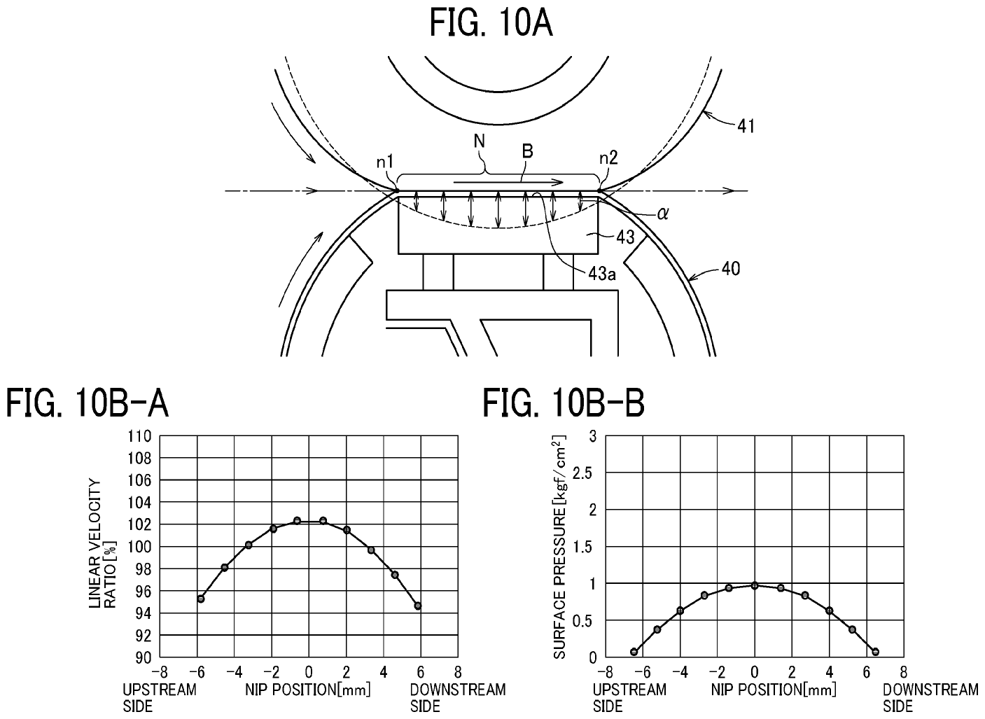

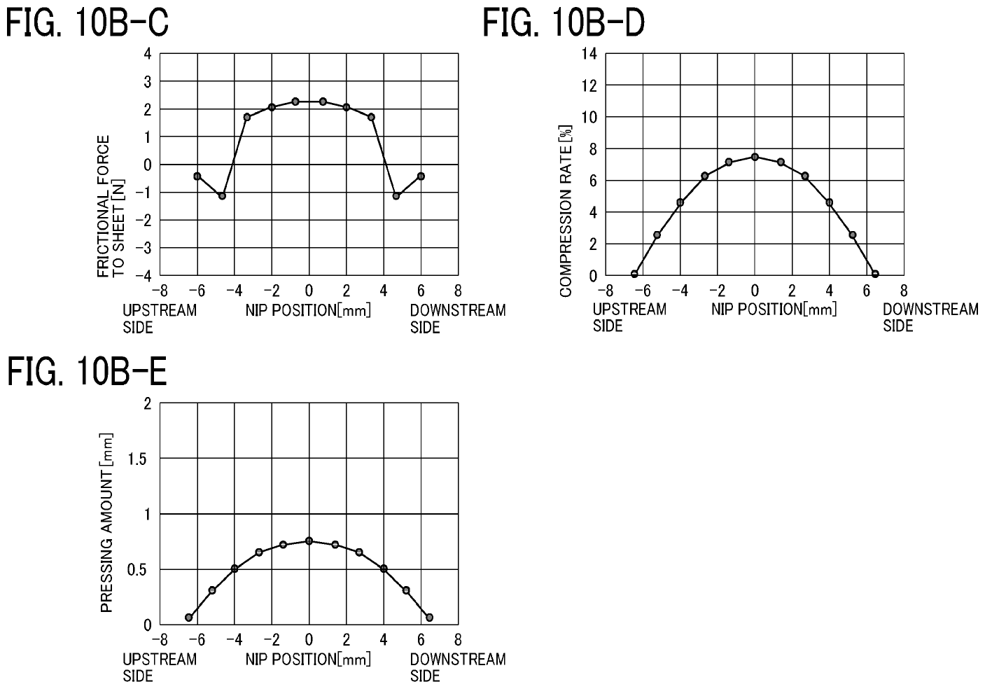

FIG. 10A is a diagram illustrating a configuration of the comparative drying device according to Comparative Example 1. In Comparative Example 1, the nip forming surface 43a of the nip formation pad 43 has a flat shape. Due to such a configuration, the pressed amount a of the pressure roller 41 is symmetrical (see FIG. 10B-E). In other words, in Comparative Example 1, the pressed amount α increases from the upstream end n1 to the center of the nip region N, but the pressed amount a decreases from the center to the downstream end n2 of the nip region N.

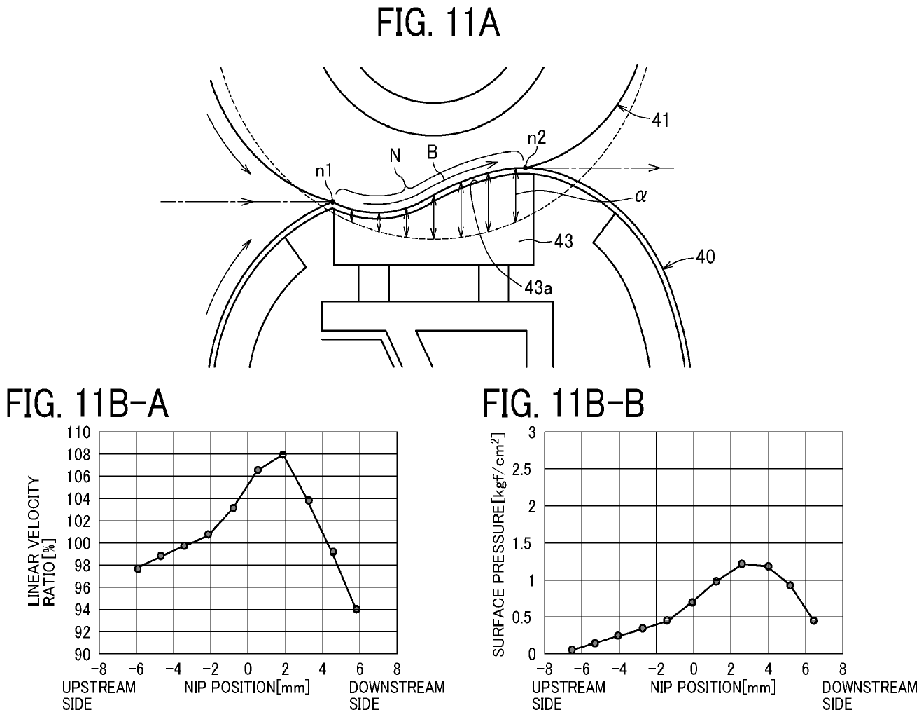

FIG. 11A is a diagram illustrating a configuration of the comparative drying device according to Comparative Example 2. In Comparative Example 2, the nip forming surface 43a of the nip formation pad 43 has a concave curved shape on the upstream side in the sheet conveyance direction B and has a convex curved shape on the downstream side in the sheet conveyance direction B. The pressed amount α of the pressure roller 41 gradually increases from the upstream end n1 toward the center of the nip region N and gradually decreases toward the downstream end n2 of the nip region N side (see FIG. 11B-E).

The evaluation results of the cockling reduction effect in this test are indicated in Table 1 below. The evaluation results were classified in the following ratings: “Excellent” represents that no cockling is visually observed (no cockling), “Good” represents that slight cockling is visually observed (low cockling level), “Acceptable” represents that some cockling is visually observed (medium cockling level), and “Poor” represents that clear cockling is visually observed (high cockling level).

TABLE 1

| | Cockling Reduction Effect |
|---|---|
| Example 1 | Excellent |
| Example 2 | Good |
| Comparative Example 1 | Acceptable |
| Comparative Example 2 | Acceptable |

As indicated in Table 1, the evaluation result of Example 1 was Excellent and the evaluation result of Example 2 was Good, and cockling was effectively reduced. That is, in Examples 1 and 2 according to the present disclosure, the pressed amount a of the pressure roller 41 increased over the entire area from the upstream end n1 to the downstream end n2 of the nip region N, and it is thought that the cockling reduction effect of the above-described tension is fully demonstrated. In particular, in Example 1 according to the present disclosure, a significant cockling reduction effect was obtained, resulting in the Excellent evaluation. Since the rate of the increase in the pressed amount α of the pressure roller 41 is greater in Example 1 than in Example 2, the linear velocity ratio difference between the upstream end n1 and the downstream end n2 of the nip region N is greater, resulting in a greater tension acting on the sheet. According to this result, it is considered that a greater cockling reduction effect was achieved.

On the other hand, the evaluation results of Comparative Example 1 and Comparative Example 2 were Acceptable. That is, in Comparative Examples 1 and 2, unlike each of the examples described above, since the pressed amount a of the pressure roller 41 does not increase over the entire area of the nip region N from the upstream end n1 to the downstream end n2 but decreases in the middle of the nip region N, it is considered the cockling reduction effect was not achieved as compared with each of the examples described above.

As described above, according to the results of this test, it was confirmed that cockling can be effectively reduced in each of the examples of the present disclosure, in which the pressed amount α of the pressure roller 41 is increased throughout the nip region N from the upstream end n1 to the downstream end n2, compared to each of the comparative examples that are different from each of the examples of the present disclosure. Further, as the increase rate of the pressed amount α increases, the difference of linear velocity ratio between the upstream end n1 and the downstream end n2 of the nip region N increases, and the tension acting on the sheet also increases. Due to such a configuration, it was also confirmed according to the results of this test a larger cockling reduction effect is achieved.

In order to obtain a larger linear velocity ratio difference, it is preferable to increase the difference between the average pressed amounts of the upstream side and the downstream side of the nip region N. Specifically, in FIG. 12, based on the center m of the sheet conveyance direction of the nip region N, the upstream half in the sheet conveyance direction is the nip front half E1 and the downstream half in the sheet conveyance direction is the nip rear half E2. It is preferable that the average pressed amount of the pressure roller 41 in the nip rear half E2 is twice or more the average pressed amount of the pressure roller 41 in the nip front half E1 of the nip. The average pressed amount is obtained, for example, by measuring the pressed amounts in the nip front half E1 and the nip rear half E2 at predetermined intervals using a laser displacement meter and by calculating the average value of the pressed amounts in each of the nip front half E1 and the nip rear half E2. In this way, by increasing the average pressed amount in the nip rear half E2 more than twice the average pressed amount in the nip front half E1, the linear velocity ratio difference between the upstream end n1 and the downstream end n2 of the nip N is increased (for example, the linear velocity ratio difference is increased to 6% or more, as indicated in the graph in FIG. 8B-A), and a large cockling reduction effect is obtained.

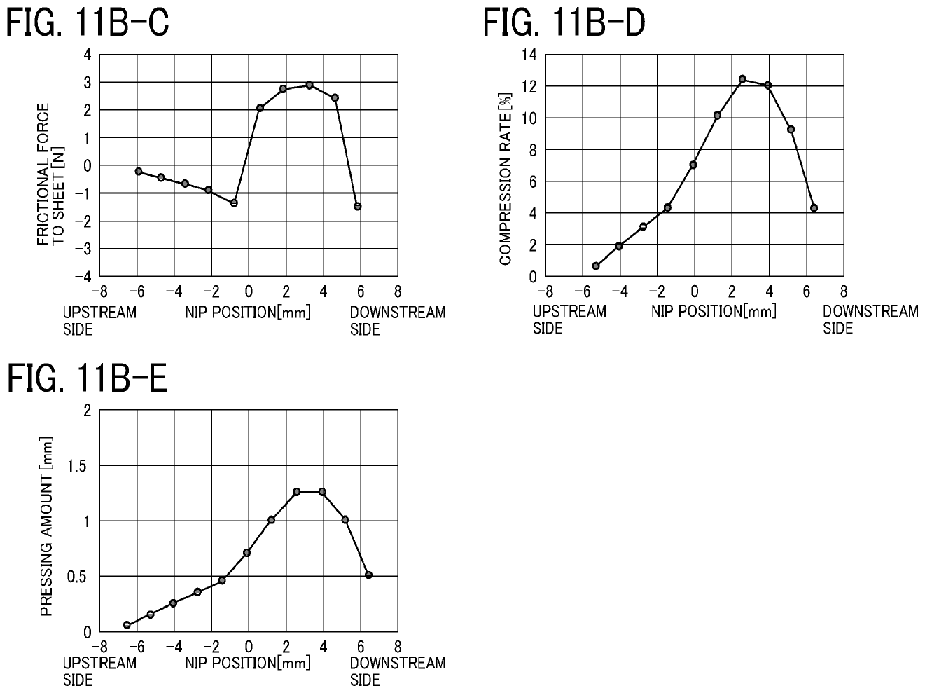

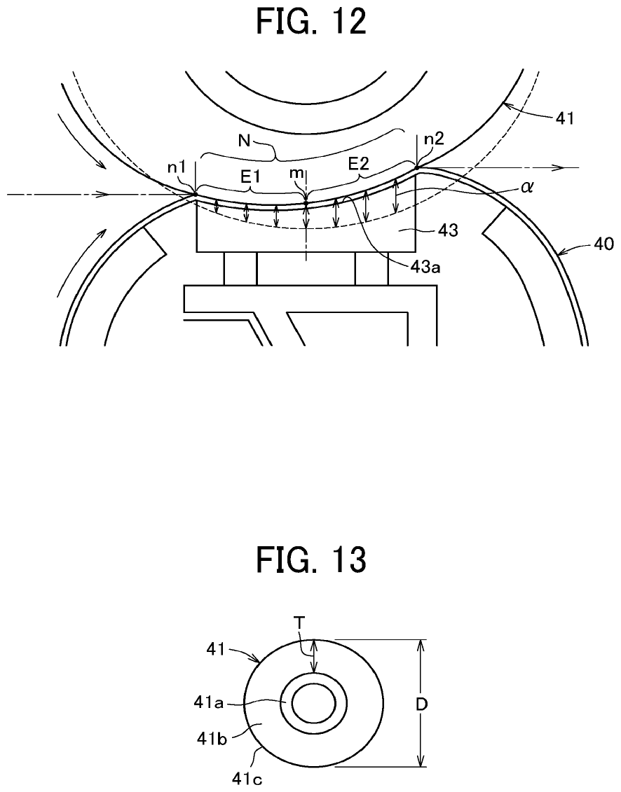

Further, as the elastic layer 41b of the pressure roller 41 is thicker, the elastic deformation rate of the pressure roller 41 is larger and the linear velocity ratio difference is larger. Due to such a configuration, as illustrated in FIG. 13, the thickness T of the elastic layer 41b of the pressure roller 41 in the non-pressed state is preferably 30% or more of the diameter (outer diameter) D of the pressure roller 41. In other words, the pressure roller 41 includes the elastic layer 41b having a thickness of preferably 30% or more of the diameter (outer diameter) D of the pressure roller 41. Further, for the same reason, the pressure roller 41 has the Acker C hardness of preferably 30 or less.

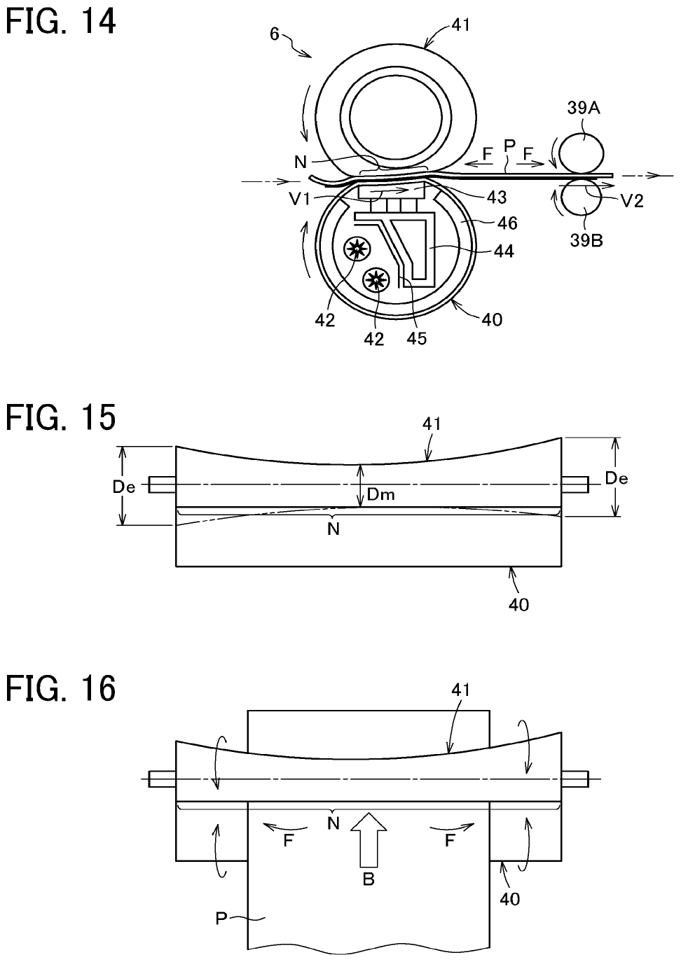

Further, as illustrated in FIG. 14, when a pair of conveyance rollers 39A and 39B, each functioning as a conveyance rotary body, to convey the sheet P are disposed downstream from the drying device 6 in the sheet conveyance direction B, the conveyance speed of the conveyance rollers 39A and 39B and the conveyance speed of the drying device 6 may be different from each other. That is, as illustrated in FIG. 14, the rotational speed (conveyance speed V1) of the heat belt 40 and the pressure roller 41 of the drying device 6 is slower than the rotational speed (conveyance speed V2) of the pair of conveyance rollers 39A and 39B. By so doing, when the sheet P is nipped between the heat belt 40 and the pressure roller 41 of the drying device 6 and between the pair of conveyance rollers 39A and 39B, tension F may be applied to the sheet P in the sheet conveyance direction B and the opposite direction to the sheet conveyance direction B. As a result, even after the sheet P is ejected from the nip region N of the drying device 6, the tension F is applied to the sheet P, so that the cockling is reduced more effectively. In particular, in order to effectively reduce the cockling, the difference between the rotational speed of the heat belt 40 and the pressure roller 41 (conveyance speed V1) and the rotational speed of the pair of conveyance rollers 39A and 39B (conveyance speed V2) is preferably 1% or more of the rotational speed of the heat belt 40 and the pressure roller 41 (conveyance speed V1).

FIG. 15 is a diagram illustrating a configuration of the drying device according to another embodiment of the present disclosure.

In the embodiment illustrated in FIG. 15, in addition to the configuration of the above-described embodiment, the outer diameter of the pressure roller 41 increases from the center to both axial ends of the pressure roller 41 in the non-pressed state, and the outer diameter is larger at both axial ends De than at the center Dm (Dm<De). Other than this difference, the configuration of the drying device 6 is basically the same as the configuration of the drying device of the above-described embodiment.

As described above, since the outer diameter of the pressure roller 41 is larger at both axial ends than at the center, the pressure roller 41 is compressed more at both axial ends than at the center in the nip region N. As a result, the surface moving speed of the pressure roller 41 is faster at both ends than at the center, and as illustrated in FIG. 16, when the sheet P enters the nip region N, the tension F that pulls the sheet P toward both axial ends of the pressure roller 41 acts on the sheet.

Accordingly, even when cockling occurs in the sheet width direction, the fibers of the sheet P are stretched uniformly in the sheet width direction by the tension F generated toward both axial ends of the pressure roller 41. Then, when the sheet P is heated in this state, the solvent that permeates the sheet P volatilizes, and the sheet P is dried with the fibers stretched uniformly. As a result, the cockling of sheet P is reduced, and the sheet P is ejected from the nip region N with the cockling being continuously reduced.

Thus, in this embodiment, by making the outer diameter of the pressure roller 41 larger at both axial ends than at the center, a tension F that pulls in the width direction acts on the sheet P to effectively reduce the cockling that occurs across the sheet width direction. Further, the tension F that pulls the sheet P in the width direction increases as the difference in the outer diameter of the pressure roller 41 between the center and both axial ends is larger. Due to such a configuration, the difference in the outer diameter of the pressure roller 41 between the center and both axial ends is preferably 0.5 mm or more. By setting the difference in the outer diameter of the pressure roller 41 to 0.5 mm or more, the cockling is reduced more reliably.

Note that, as in the embodiment described above, the pressed amount α of the pressure roller 41 in the present embodiment is configured to increase from the upstream end n1 toward the downstream end n2 of the nip region N. Due to such a configuration, also in the present embodiment, the above-mentioned effect is produced on the sheet P to effectively reduce the cockling that occurs in the sheet conveyance direction B.

FIG. 17 is a diagram illustrating a configuration of the drying device according to yet another embodiment of the present disclosure.

The drying device 6 illustrated in FIG. 17 includes a moving roller 47, a connecting member 48, a gear train 49, and a belt support 50 in addition to a heat belt 40, a pressure roller 41, a heater 42, and a nip formation pad 43. The heat belt 40, the pressure roller 41, and the nip formation pad 43 basically have the same configurations and functions in the present embodiment and the above-described embodiment. In FIG. 17, the stay 44, the reflector 45, and the belt holding member 46 described above are omitted.

The moving roller 47 is disposed upstream (left side in FIG. 17) from the pressure roller 41 in the sheet conveyance direction. Further, the pressure roller 41 and the moving roller 47 are rotatably connected to each other via the connecting member 48. The connecting member 48 is attached to the pressure roller 41 so as to rotate around the rotation axis of the pressure roller 41 in the direction indicated by arrow J in FIG. 17. Due to such a configuration, the moving roller 47 moves in the direction of approaching or separating from the heat belt 40 together with rotation of the connecting member 48.

The pressure roller 41 and the moving roller 47 are connected by a gear train 49 including a plurality of gears 51 to 53 as power transmission members. Specifically, the gear train 49 includes of a moving roller gear 53 that rotates with the moving roller 47, a pressure roller gear 51 that rotates with the pressure roller 41, and an middle gear 52 that is disposed between the moving roller gear 53 and the pressure roller gear 51 and meshes with the moving roller gear 53 and the pressure roller gear 51. Since the moving roller 47 and the pressure roller 41 are connected to each other via the gear train 49, when the pressure roller 41 is driven to rotate, the driving force of the pressure roller 41 is transmitted to the moving roller 47, and the moving roller 47 rotates in the same direction in conjunction with the pressure roller 41.

The belt support 50 is a member that supports the heat belt 40 from the inside of the loop of the heat belt 40 when the moving roller 47 approaches the heat belt 40 and when the moving roller 47 contacts the heat belt 40. In present embodiment, the belt support 50 is configured as a single unit with the nip formation pad 43 but may be configured separately from the nip formation pad 43.

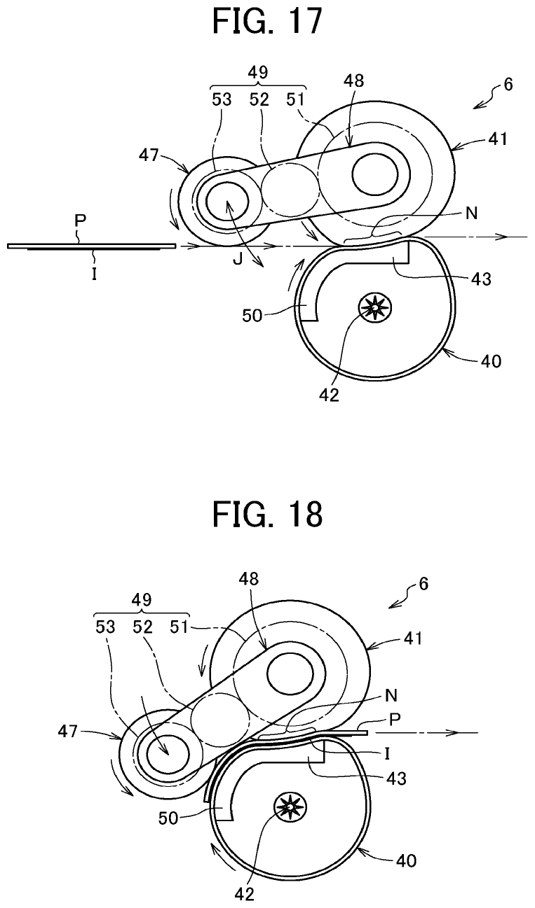

As illustrated in FIG. 18, in the present embodiment, when the sheet P to which ink I is applied is conveyed to the drying device 6, the trailing end of the sheet P is nipped between the moving roller 47 and the heat belt 40 as the moving roller 47 moves to approach the heat belt 40 while the sheet P is passing through the nip region N. As a result, the trailing end of the sheet P is pressed against the heat belt 40, and the liquid-applied surface (lower surface in FIG. 18) of the sheet P to which ink I (liquid) is applied is curved to form a concave shape in the sheet conveyance direction. Then, the sheet P is conveyed with the trailing end of the sheet P pressed against the heat belt 40, then passes through the nip region N, and is ejected from the drying device 6.

Thus, in the drying device 6 of the present embodiment, the trailing end of the sheet P is pressed against the heat belt 40 by the moving roller 47, and the liquid-applied surface of the sheet P is curved to form a concave shape in the conveyance direction. As a result, the drying device 6 according to the present embodiment reduces the deformation of the sheet P such that the liquid-applied surface becomes convex. The deformation is referred to as a back curl. Further, in the present embodiment, the moving roller 47 rotates in conjunction with the pressure roller 41 while the sheet P is pressed against the heat belt 40, so the sheet P is smoothly conveyed by the rotating moving roller 47. Note that, a non-rotating member (moving member) may be used instead of the moving roller 47 if some transfer resistance is acceptable. Further, as in the above-described embodiment, the pressed amount of the pressure roller 41 in the present embodiment is configured to increase from the upstream end to the downstream end of the nip region N. Due to such a configuration, the drying device 6 according to the present embodiment effectively reduces the deformation of the sheet including the cocking by causing the sheet P to pass through the nip region N.

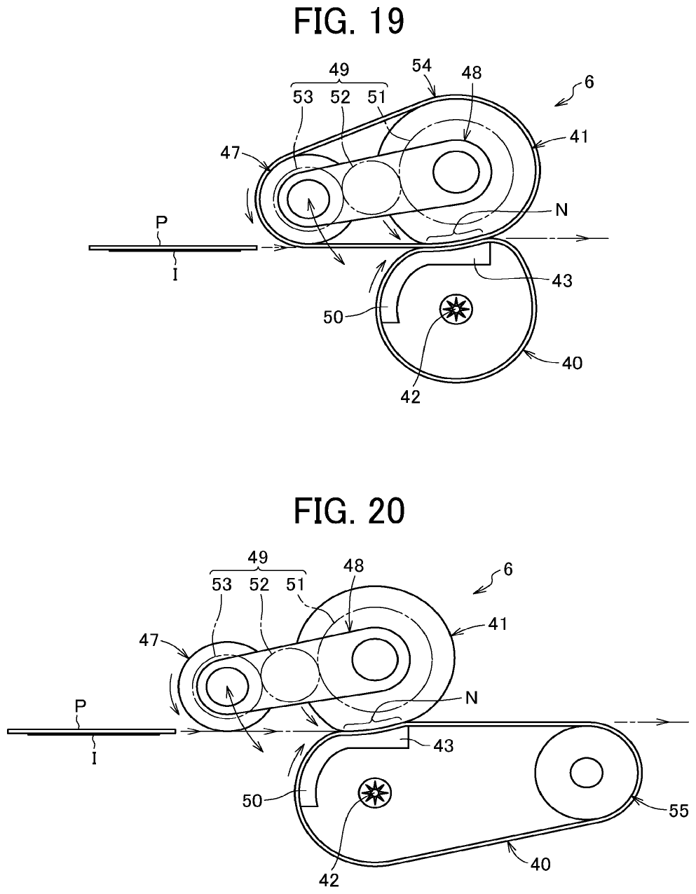

As illustrated in the modified configuration of the drying device 6 in FIG. 19, a belt member 54 having an endless loop may be wound around the pressure roller 41 and the moving roller 47. In this case, when the moving roller 47 approaches the heat belt 40, the trailing end of the sheet P is pressed against the heat belt 40 by the belt member 54, thereby ensuring a wide area to press the sheet P and reducing the flapping of the trailing end of the sheet P. As a result, the sheet P closely contacts the heat belt 40 over a wide range more reliably, and the sheet P is effectively heated. Further, also in this case, since the surface moving speed of the pressure roller 41 increases toward the downstream side of the sheet conveyance direction of the nip region N, the conveyance speed of the sheet P increases following the surface moving speed of the pressure roller 41, thereby effectively reducing cockling by the difference between the surface moving speed of the upstream side and the surface moving speed of the downstream side. Further, the gear train 49 illustrated in FIG. 19 may be omitted. In that case, the belt member 54 may be used as a power transmission member to transmit driving force between the pressure roller 41 and the moving roller 47.

Further, as illustrated in the modified configuration of the drying device 6 in FIG. 20, a roller 55 may be disposed downstream from the nip formation pad 43 in the conveyance direction B (right side in FIG. 20), and the heat belt 40 may be wound around the roller 55.

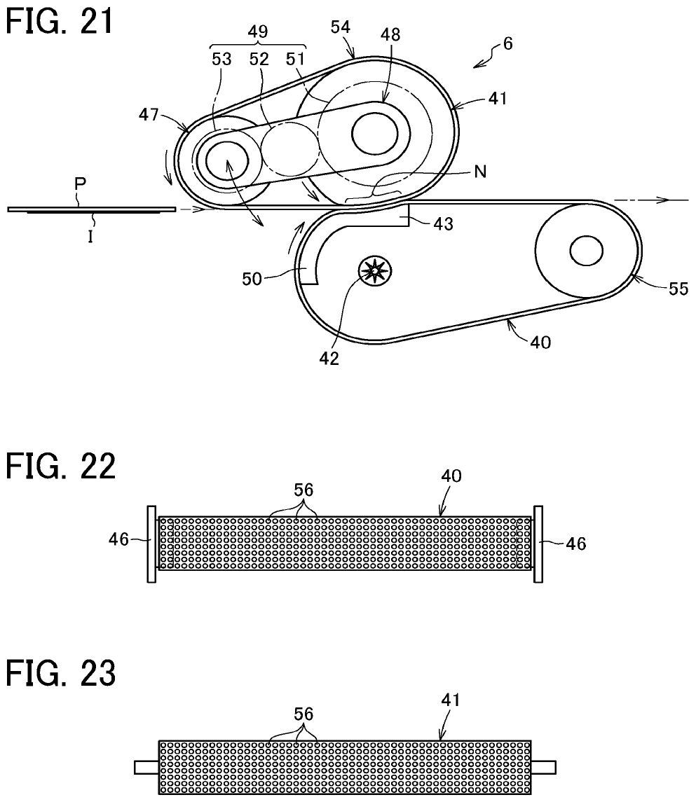

Furthermore, the drying device 6 may employ a configuration that combines the modified configurations of the drying device 6 illustrated in FIG. 19 and FIG. 20, as in the modified configuration of the drying device 6 illustrated in FIG. 21.

Further, in order to restrain sticking of the sheet P to the heat belt 40 or to the pressure roller 41, a heat belt 40 illustrated in FIG. 22 or a pressure roller 41 illustrated in FIG. 23 may be employed. As illustrated in FIGS. 22 and 23, each of the heat belt 40 of FIG. 22 and the pressure roller 41 of FIG. 23 is provided with a plurality of concave portions (or a plurality of convex portions) on the outer circumferential surface. In this case, since the contact area of each of the heat belt 40 and the pressure roller 41 to the sheet P is reduced, the sheet P is less likely to adhere to the heat belt 40 and the pressure roller 41, and sticking of the sheet P to the heat belt 40 and the pressure roller 41 is restrained. In addition, by reducing the contact area, distortion of the ink (image) on the sheet P is reduced.

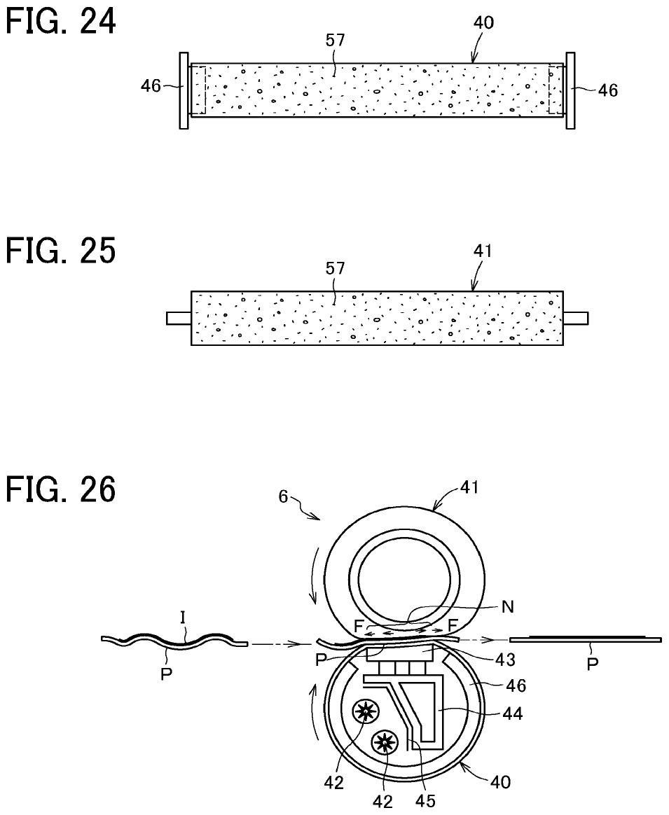

For the same reason, the heat belt 40 or the pressure roller 41 may employ an abrasive belt or abrasive roller having the outer circumferential surface on which abrasive grains 57 such as a plurality of ceramic or glass are attached, as illustrated in FIGS. 24 and 25.

In the above-described embodiment, as illustrated in FIG. 7, when the sheet P with ink I applied to a single face is conveyed to the drying device 6, the sheet P enters the nip region N with the liquid-applied surface with ink I (liquid) facing the heat belt 40. Due to such a configuration, the liquid-applied surface is effectively heated by the heat belt 40, and this configuration accelerates the drying of the ink I. However, the present disclosure is not limited to a configuration in which the liquid-applied surface of the sheet P is conveyed while facing the heat belt 40 but may also have a configuration in which the liquid-applied surface is conveyed while facing the pressure roller 41, as illustrated in the configuration of the drying device 6 in FIG. 26. In this case, as in the above-described embodiment, cockling is effectively reduced.

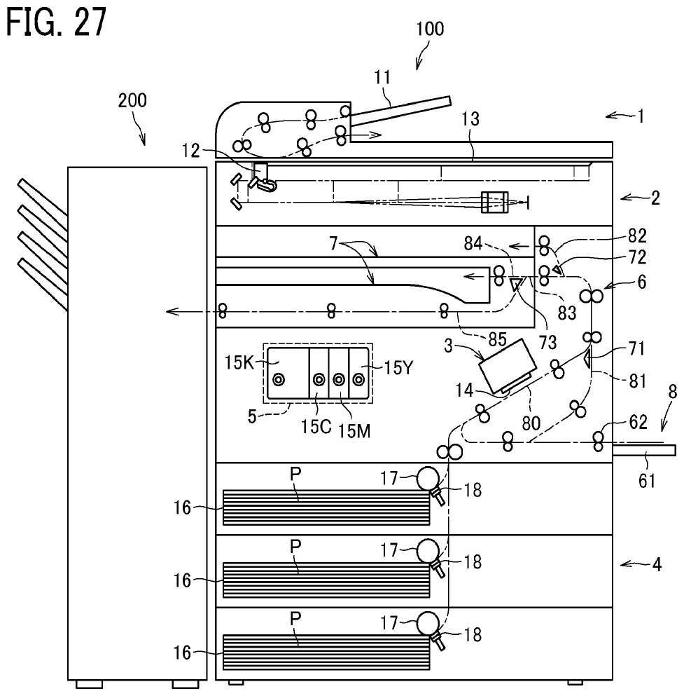

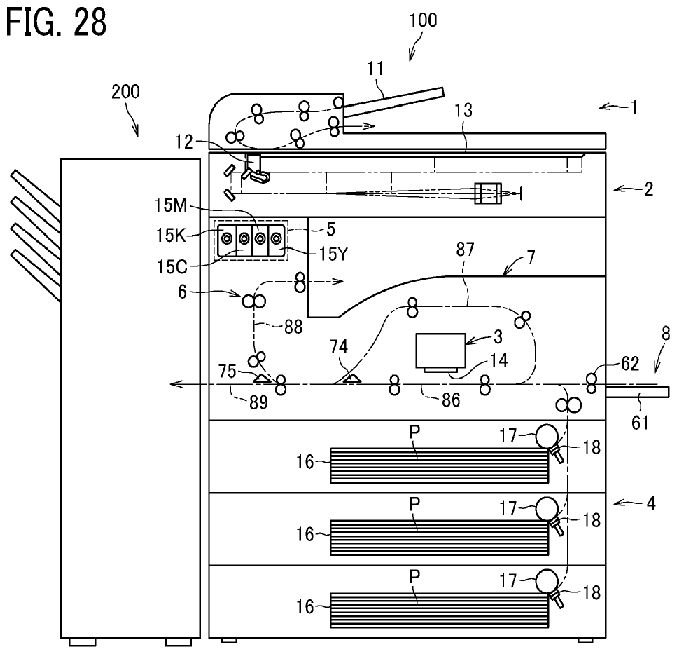

The various configurations of the drying device (heating device) according to the present disclosure have been described above. However, the drying device (heating device) is not limited to the image forming apparatus in FIG. 1, but also be disposed in other image forming apparatus such as those illustrated in FIGS. 27 and 28.

Next, a description is given of the configuration of each image forming apparatus with reference to FIGS. 27 and 28. FIG. 27 is a diagram illustrating a configuration of an image forming apparatus according to another embodiment of the present disclosure. FIG. 28 is a diagram illustrating a configuration of an image forming apparatus according to yet another embodiment of the present disclosure. Note that the following description is given of the configuration of the image forming apparatus 100 of FIGS. 27 and 28 different from the configuration of the image forming apparatus 100 according to the above-described embodiment. That is, the description of the configuration of the image forming apparatus 100 of FIGS. 27 and 28 that is same as the configuration of the image forming apparatus 100 according to the above-described embodiment is omitted.

The image forming apparatus 100 illustrated in FIG. 27 includes an original document conveying device 1, an image reading device 2, an image forming device 3, a sheet feeding device 4, a cartridge container 5, a drying device (heating device) 6, and a sheet ejection portion 7 as in the above-described embodiment, as well as a bypass sheet feeding device 8. However, different from the image forming device 3 in FIG. 1, the image forming device 3 in FIG. 27 is disposed facing a sheet conveyance passage 80 in which the sheet P is conveyed in a direction obliquely to the horizontal direction.

The bypass sheet feeding device 8 includes a bypass tray 61 and a bypass sheet feed roller 62. The bypass tray 61 functions as a sheet loader to load the sheet P. The bypass sheet feed roller 62 functions as a sheet feed body to feed the sheet P from the bypass tray 61. The bypass tray 61 is attached to open and close with respect to the housing of the image forming apparatus 100. In other words, the bypass tray 61 is rotatably attached to the housing of the image forming apparatus 100. When the bypass tray 61 is open (state in FIG. 27), the sheet P or the bundle of sheets including the sheet P is loaded on the bypass tray 61 and is fed from the bypass tray 61 to the housing of the image forming apparatus 100.

In the image forming apparatus 100 illustrated in FIG. 27, as a print job start instruction is issued, the sheet P is supplied from the sheet feeding device 4 or from the bypass sheet feeding device 8 and is conveyed to the image forming device 3. When the sheet P is conveyed to the image forming device 3, ink is discharged from the liquid discharge head 14 onto the sheet P to form an image on the sheet P.

When performing the duplex printing, after the sheet P passed the image forming device 3, the sheet P is then conveyed in the opposite direction opposite the sheet conveyance direction. Then, a first passage changer 71 guides the sheet P to a sheet reverse passage 81. Then, as the sheet P passes through the sheet reverse passage 81, the sheet P is reversed from the front face to the back face, and then is conveyed to the image forming device 3 again to form an image on the back face of the sheet P.

The sheet P having the image on one side or both sides is conveyed to the drying device 6 in which the ink on the sheet P is dried. Note that, when drying the ink on the front face of the sheet P and then forming an image on the back face of the sheet P, the drying device 6 may dry the ink on the front face of the sheet P first, and then, the sheet P may be conveyed in a sheet conveyance passage that detours the drying device 6. Then, the direction of conveyance of the sheet P may be switched back (changed) to the upstream side from the drying device 6 in the sheet conveyance direction, and the sheet P may preferably be guided to the image forming device 3 again via the sheet reverse passage 81. After the sheet P passed the drying device 6, a second passage changer 72 guides the sheet P selectively to a sheet conveyance passage 82 that runs toward the upper sheet ejection portion 7 or to a sheet conveyance passage 83 that runs to the lower sheet ejection portion 7. In a case in which the sheet P is guided to the sheet conveyance passage 82 toward the upper sheet ejection portion 7, the sheet P is ejected to the upper sheet ejection portion 7. On the other hand, when the sheet P is guided to the sheet conveyance passage 83 toward the lower sheet ejection portion 7, a third passage changer 73 guides the sheet P selectively to a sheet conveyance passage 84 toward the lower sheet ejection portion 7 or to a sheet conveyance passage 85 toward the post-processing apparatus 200.

Then, when the sheet P is guided to the sheet conveyance passage 84 toward the lower sheet ejection portion 7, the sheet P is ejected to the lower sheet ejection portion 7. On the other hand, when the sheet P is guided to the sheet conveyance passage 85 toward the post-processing apparatus 200, the sheet is conveyed to the post-processing apparatus 200, so that the post-processing operation is performed on the sheet P.

Similar to the image forming apparatus 100 illustrated in FIG. 27, the image forming apparatus 100 illustrated in FIG. 28 includes the original document conveying device 1, the image reading device 2, the image forming device 3, the sheet feeding device 4, the cartridge container 5, the drying device (heating device) 6, the sheet ejection portion 7, and the bypass sheet feeding device 8. Note that, in this case, similar to the image forming device 3 in FIG. 1, the image forming device 3 in FIG. 28 is disposed facing a sheet conveyance passage 86 in which the sheet P is conveyed in the horizontal direction.

In the image forming apparatus 100 illustrated in FIG. 28, as a print job start instruction is issued, the sheet P is supplied from the sheet feeding device 4 or from the bypass sheet feeding device 8 and is conveyed to the image forming device 3. When the sheet P is conveyed to the image forming device 3, ink is discharged from the liquid discharge head 14 onto the sheet P to form an image on the sheet P.

When performing the duplex printing, after the sheet P has passed the image forming device 3, the sheet P is then conveyed in the opposite direction opposite the sheet conveyance direction. Then, a first passage changer 74 guides the sheet P to a sheet reverse passage 87. Then, as the sheet P passes through the sheet reverse passage 87, the sheet P is reversed from the front face to the back face and is conveyed to the image forming device 3 again, so that an image is formed on the back face of the sheet P.

After an image is formed on one side or both sides of the sheet P, a second passage changer 75 guides the sheet P selectively to a sheet conveyance passage 88 that runs toward the drying device 6 or to a sheet conveyance passage 89 that runs to the post-processing apparatus 200. When the sheet P is guided to the sheet conveyance passage 88 toward the drying device 6, the drying device 6 dries the ink on the sheet P. Note that, when drying the ink on the front face of the sheet P and then forming an image on the back face of the sheet P, the drying device 6 may dry the ink on the front face of the sheet P first, and then, the sheet P may be conveyed in a sheet conveyance passage that detours the drying device 6. Then, the direction of conveyance of the sheet P may be switched back (changed) to the upstream side from the sheet conveyance passage 88 (upstream sides from the drying device 6) in the sheet conveyance direction, and the sheet P may preferably be guided to the image forming device 3 again via the sheet reverse passage 87. Consequently, the sheet P that passed the drying device 6 is ejected to the sheet ejection portion 7. On the other hand, when the sheet P is guided to the sheet conveyance passage 89 toward the post-processing apparatus 200, the sheet P is conveyed to the post-processing apparatus 200, so that the post-processing operation is performed on the sheet P.

By providing the drying device 6 according to the present disclosure in the image forming apparatus 100 illustrated in FIGS. 27 and 28, deformation of sheet such as cockling is effectively restrained. As a result, this configuration reduces or eliminates the inconvenience such as a sheet conveyance failure and a decrease in the number of sheets stackable in a sheet ejection tray.

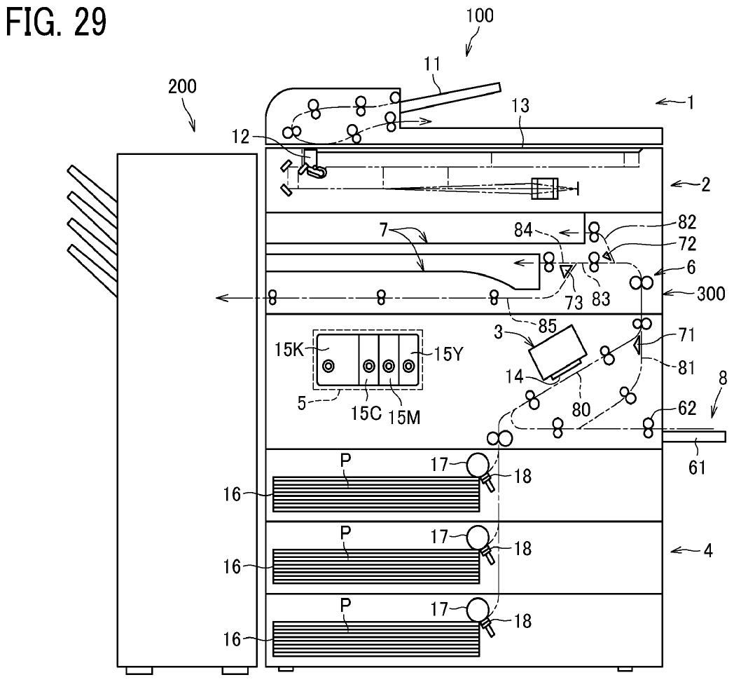

The drying device (heating device) according to the present disclosure is not limited to be provided on image forming apparatus as described above, but may also be provided on a conveying device that is detachably attached to the image forming apparatus. For example, the conveying device 300 illustrated in FIG. 29 is detachably attached between the image reading device 2 and the image forming device 3 of the image forming apparatus 100, and includes a drying device 6, a sheet ejection portion 7, sheet conveyance passages 82 and 84 for conveying the sheet to the sheet ejection portion 7, and sheet conveyance passage 85 for conveying the sheet to the post-processing apparatus 200 (post-processing device). The conveying device 300 may employ the configuration of the present disclosure as a drying device 6.

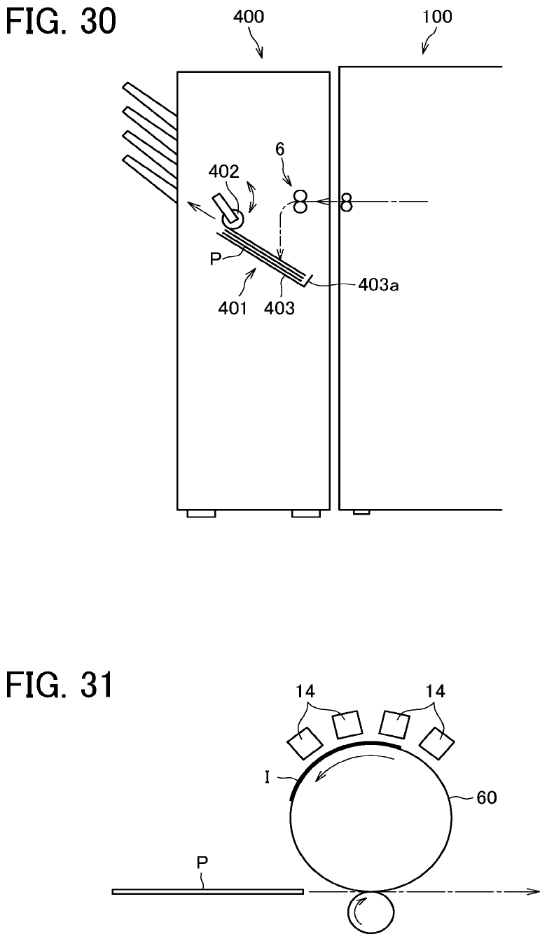

Further, the drying device (heating device) may be also disposed in a post-processing apparatus 400 as illustrated in FIG. 30. The post-processing apparatus 400 illustrated in FIG. 30 includes a drying device 6 and a post-processing device 401 that performs post-processing on the sheet that has passed through the drying device 6, in other words, the sheet that is conveyed from the drying device 6. As the sheet is conveyed from the image forming apparatus 100 to the post-processing apparatus 400, the sheet is heated by the drying device 6 and is stacked on a sheet stacking tray 403 of the post-processing device 401. At this time, in a case in which the sheet is stacked on the sheet stacking tray 403 with the printed face up (with the image forming surface facing up), the order of image formation may be set to be reversed, in other words, the image may be formed from the last page first. Further, the sheet P stacked on the sheet stacking tray 403 is conveyed by a conveyance roller 402 provided in the post-processing device 401 in the reverse direction with the trailing end to the leading end. By so doing, the trailing end of the sheet P contacts a trailing end regulator 403a of the sheet stacking tray 403, so that the position of the trailing end of the sheet P is aligned. Further, in order not to hinder ejection of the sheet to the sheet stacking tray 403, the conveyance roller 402 is disposed to be movable from a position at which the conveyance roller 402 contacts the sheet P to a retreat position at which the conveyance roller 402 does not contact the sheet P. In the state in which the position of the trailing end of the sheet P is aligned, the post-processing is performed on the sheet P such as the stapling process and the punching process. Thereafter, the conveyance roller 402 rotates in the reverse direction, and the sheet P on the sheet stacking tray 403 is ejected to the outside of the post-processing apparatus 400. As the drying device provided in the post-processing apparatus 400 employs the configuration according to the present disclosure, the drying device 6 effectively restrains deformation such as cockling of the sheet, and improves problem such as sheet conveyance failure and a decrease in the number of sheets stackable in a sheet ejection tray.

In the present disclosure, the “liquid” discharged from a liquid discharge head includes any liquid having a viscosity or a surface tension that is discharged from the liquid discharge head. However, preferably, the viscosity of the liquid is not greater than 30 mPa·s by heating or cooling under ordinary temperature and ordinary pressure. More specifically, examples of such liquid include solutions, suspensions, and emulsions containing solvents such as water and organic solvents, colorants such as dyes and pigments, functional materials such as polymerizable compounds, resins, and surfactants, biocompatible materials such as DNA, amino acids and proteins, and calcium, and edible materials such as natural dyes. Such liquid may be used, for example, as inkjet inks, surface treatment solutions, and solutions for forming components of electronic devices and light-emitting devices, and electronic circuit resist patterns.

Further, examples of an energy source in the liquid discharge head to generate energy to discharge liquid include a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

The “liquid applier” for applying liquid to the sheet is not limited to a device to apply liquid to visualize meaningful images, such as letters or figures. For example, the liquid applier may be a device to form meaningless images, such as meaningless patterns or a device to apply a treatment solution to the surface of the sheet for purposes such as modifying the surface of the sheet. That is, the drying device (heating device) according to the present disclosure may be applied to a liquid applying apparatus that applies a liquid that does not form an image, in addition to an imaging forming apparatus.

Further, the “liquid applier” is not limited to a device employing the method of directly discharging liquid from the nozzle onto the sheet, but is also a device employing a method of indirectly applying liquid onto the sheet P by discharging ink I from the liquid discharge head 14 onto the drum-shaped rotary body 60 and bringing the rotary body 60 with ink I applied to the surface into contact with the sheet P, as illustrated in FIG. 31.

The above-described term “sheet” denotes, for example, a material or a medium onto which liquid adheres at least temporarily, and which adheres and sticks, or which adheres and permeates. Examples of the sheet include paper (plain paper) as well as thick paper, postcards, envelopes, thin paper, coated paper (coated paper, art paper, etc.), tracing paper, OHP sheets, plastic film, prepreg, metal foil, cloth, etc.

In each of the above-described embodiments, the present disclosure is applied to a drying device that is an example of a heating device. However, the heating device according to the present disclosure is not limited to a device to heat sheets for the purpose of drying. The present disclosure is also applied to heating devices that heat sheets for purposes other than drying.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A heating device comprising:
a pair of rotary bodies including a first rotary body and a second rotary body in contact with each other to form a nip region,
the pair of rotary bodies being configured to convey a sheet on which liquid is applied while nipping the sheet,
a pressed amount of the second rotary body by the first rotary body increasing from an upstream end of the nip region toward a downstream end of the nip region in a sheet conveyance direction; and
a heat source configured to heat at least one of the first rotary body and the second rotary body.

2. The heating device according to claim 1,
wherein the nip region is formed in a concave curved shape that is concave toward the first rotary body from the upstream end of the nip region toward the downstream end of the nip region in the sheet conveyance direction, and
wherein the downstream end of the nip region is closer to an axial center of the second rotary body than the upstream end of the nip region is.

3. The heating device according to claim 1,
wherein an average of the pressed amount of the second rotary body in a nip rear half is twice or more an average of the pressed amount of the second rotary body in a nip front half, where, with respect to a center of the nip region in the sheet conveyance direction, the nip rear half represents a downstream half of the nip region in the sheet conveyance direction and the nip front half represents an upstream half of the nip region in the sheet conveyance direction.

4. The heating device according to claim 1,
wherein the second rotary body has an elastic layer having a thickness of 30% or more of an outer diameter of the second rotary body.

5. The heating device according to claim 1,
wherein the second rotary body has an Asker C hardness of 30 or less.

6. The heating device according to claim 1,
wherein an outer diameter of the second rotary body is larger at each of axial ends of the second rotary body than at an axial center of the second rotary body.

7. The heating device according to claim 6,
wherein a difference in the outer diameter of the second rotary body between the axial center and each of the axial ends is 0.5 mm or more.

8. The heating device according to claim 1,
wherein a rotational speed of the pair of rotary bodies is slower than a rotational speed of a conveyance rotary body disposed downstream from the pair of rotary bodies and configured to convey the sheet in the sheet conveyance direction, and
wherein a difference between the rotational speed of the pair of rotary bodies and the rotational speed of the conveyance rotary body is 1% or more of the rotational speed of the pair of rotary bodies.

9. A liquid applying apparatus comprising:
a liquid applier configured to apply liquid to a sheet; and
the heating device according to claim 1.

10. An image forming apparatus comprising:
an image forming device configured to apply liquid to a sheet to form an image; and
the heating device according to claim 1.

11. A post-processing apparatus comprising:
the heating device according to claim 1; and
a post-processing device configured to process the sheet conveyed from the heating device.

12. A conveying device comprising:
the heating device according to claim 1; and
a sheet conveyance passage configured to convey the sheet to a post-processing device configured to process the sheet conveyed from the heating device.
